(19) United States
(12) Patent Application Publication
(10) Pub. No.: US 2007/0114694 A1
(43) Pub. Date: May 24, 2007

(54) Process and device for the expansion of a safety support

(75) Inventors: Jean-Jacques Azam, Clermont-Ferrand (FR); Gerard Bor, La Roche-Noire (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/603,630

(22) Filed: Nov. 22, 2006

(30) Foreign Application Priority Data
Nov. 22, 2005 (FR) 05/11927

(51) Int. Cl. B29C 65/00

(52) U.S. Cl. 264/41; 425/402

(57) ABSTRACT

Expansion process for at least one blank of a toroid ring (2) formed of an elastomeric material, comprising a stage of partial cross-linking, the said toroid ring being designed, when fully cross-linked and expanded, to constitute at least in part a safety support with a closed-cell alveolar structure, the said support being designed to be fitted on a wheel rim inside a tire, in which on completion of the partial cross-linking phase the toroid ring (2) is placed in an oven (1) to undergo an expansion phase therein, characterised in that during the expansion phase the toroid ring (2) is rotated in a vertical plane by a horizontal rotating spindle (3) which supports the said toroid ring along its inner circumference.

The invention concerns run-flat systems designed for fitting on automobile vehicles. These systems comprise a wheel rim provided with a valve, a tire, and enclosing a safety support of approximately toroidal shape, made on the basis of a foam and hereinafter called a foam support. Safety supports of this type can be used for example for fitting on vehicles or machines designed to travel over rough ground, and their purpose is to compensate the effects of a pressure loss in the tire and enable the vehicle to continue driving over a given distance.

The present invention relates to foam supports having an alveolar structure with closed cells. For example, such foam supports can be made of a diene elastomer based on butyl rubber. In some cases the alveolae can contain a gas under pressure.

The fabrication stages of these supports generally include a first stage in which the rubber is worked thermo-mechanically, during which the rubber composition is kneaded and mixed with reinforcing filters such as carbon blacks, with products designed to bring about cross-linking, and finally with foaming agents which enable the closed-cell alveolar structure to be subsequently obtained.

In a second formation stage the rubber composition obtained in the previous stage is shaped by extrusion of a blank or by direct injection into a mould.

Once in place in the mould, the blank is cross-linked at least partially during a third stage of curing at a temperature usually between 130° C. and 160° C.

Finally, in a fourth stage carried out in an oven, the blank released from its mould is expanded. The oven is at atmospheric pressure and the temperature in it is close to the curing temperature, and between 130° C. and 150° C.

It is during this stage that the expansion agents decompose and form the alveolar system within the structure of the material.

The expansion stage also goes together with an increase in the volume of the toroid ring, whose section and diameter are both multiplied by a factor of 2 or 3 during this phase.

Under these conditions it is absolutely essential to control the dimensions of the toroid ring since any geometrical irregularity will have an appreciable effect on the performance of the support when it is used in a tire.

A first solution consists in carrying out the said expansion phase in the mould or directly inside the cavity of the tire intended to receive the foam roll, as described for example in the patent FR 2 095 535. This procedure has the disadvantage that it does not enable a homogenous distribution of the density and size of the cells in a section of the foam because of the dimensional constraint imposed by the mould.

Another solution is to carry out the activation phase of the expansion agents under controlled temperature and pressure conditions, as described in the patent EP 1 155 801. To that end the foam roll is arranged on the surface of a plate, on which it is free to vary its volume.

It is found, however, that this process does not give a toroid ring whose section, in the free state, is perfectly identical all round its circumference. Moreover, the reproducibility of the dimensional characteristics from one foam roll to the net still falls far short of what is demanded by the automobile mass production industry.

The purpose of the process and device according to the present invention is to improve the control of the dimensional evolution of the foam roll during the expansion stage.

In effect, much better results can be obtained by placing the toroid ring obtained immediately after the curing stage as described above, in an oven through whose cavity circulates an airflow which enables the temperature to be regulated to the desired level, and in which the toroid ring is moved in rotation in a vertical plane by a horizontal rotating spindle which supports the said toroid ring along its inner circumference.

In effect, it is found that this particular arrangement of the foam roll during the expansion phase in the oven enables geometrical and structural asymmetries to be avoided.

In effect, it has been observed that the kinetics of the chemical reaction of the foaming agents that takes place during the said expansion phase are extremely sensitive to the slightest temperature variations. Accordingly, any elements likely to introduce slight perturbations of the heat exchange flows between the toroid ring and the airflow disturb the reaction and produce irregularities of shape which are then difficult to eliminate.

It is therefore important for each element of material in a given section of the toroid ring to receive an amount of heat energy in accordance with the most constant and symmetrical distribution possible.

By positioning the toroid ring vertically during expansion, the influence of a horizontal support element is avoided, such as a plate which would be likely to disturb the heat flow and introduce heterogeneities related to heat conduction phenomena with the face of the ring in contact with the said plate. The rotating spindle, which comes in contact with a given radial section of the ring only once during each turn, enables the effects of mechanical stresses related to the action of gravity and friction, and heat exchange irregularities, to be neutralised.

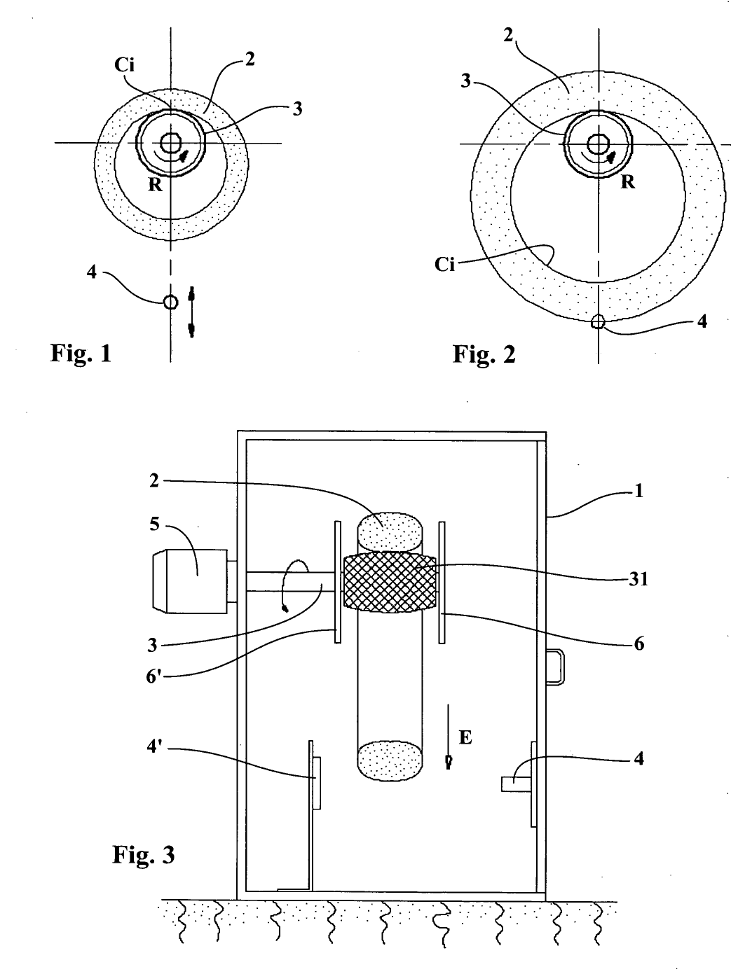

The invention's implementation is illustrated in FIGS. 1 to 3, in which:

FIG. 1 shows a schematic front view of a toroid ring at the beginning of the expansion phase,

FIG. 2 shows a schematic front view of a toroid ring at the end of the expansion phase,

FIG. 3 shows a schematic sectional view of an oven according to the invention.

FIG. 1 shows a toroid ring 2 designed to form a safety support of the foam roll type, at the beginning of the expansion phase, i.e. just after the said ring 2 has been extracted from the vulcanisation mould. The toroid ring is supported by a rotating spindle 3 placed horizontally. Contact between the toroid ring 2 and the horizontal spindle 3 takes place along the inner circumference Ci of the toroid ring 2.

The toroid ring is rotated in the same direction R as the rotating spindle 3. For the proper efficacy of heat exchanges, the rotation speed of the toroid ring is between 0.1 rad/sec and 2 rad/sec, bearing in mind that the rotation speed of the ring also varies as a function of the increase in diameter at a constant drive speed of the rotating spindle. Preferably, this rotation speed is of the order of 0.5 rad/sec.

FIG. 2 shows the toroid ring at the end of the expansion phase. Owing to its diameter increase, the toroid ring thereafter occupies the lower volume of the oven. An optical cell can be arranged so as to indicate that the toroid ring has reached the desired diameter and that the ring must be taken out of the oven.

FIG. 3 shows a schematic sectional view of an oven 1 comprising a rotating spindle 3 driven by a motor 5. The portion 31 of the rotating spindle that supports the toroid ring 2 has a barrelled shape so as to produce a self-centring effect of the ring on the roller. To improve the driving action, the barrelled surface can be knurled or striated.

Lateral flanges 6, 6′ can also be arranged so as to avoid any risk that the ring might fall off during its expansion. The flanges are preferably mounted to rotate freely relative to the rotating spindle 3.

The optical cell 4 is positioned opposite a reflector 4′ which enables the signal emitted to be reflected back. An alternative to this arrangement can consist in positioning a number of cells vertically one under the other, so as to follow through time the evolution of the expansion in the vertical direction indicated by the arrow E and, in accordance with specific laws, correct the parameters of a second part of the expansion phase as a function of the expansion rate measured during a first part of the expansion phase.

The temperature within the oven is regulated by a circulating flow of hot air (not represented) so as to maintain, as already said, a temperature generally between 120° C. and 160° C. and preferably between 140° C. and 150° C. To ensure that this circulation of hot air results in the minimum of heat exchange irregularities, the airflow in the oven should be symmetrical relative to a vertical place perpendicular to the rotating spindle 3. The portion 31 supporting the toroid ring 2 is then centred around this plane of symmetry.

The pressure inside the oven is equal to atmospheric pressure, but it is clear that this arrangement of the toroid ring during the expansion phase can be adapted to any other manner of implementation, in particular when the expansion phase is carried out under pressure.

1. An expansion process for at least one blank of a toroid ring (2) formed of an elastomeric material, comprising a stage of partial cross-linking, the said toroid ring being designed, when fully cross-linked and expanded, to constitute at least in part a safety support with a closed-cell alveolar structure, the support being designed to be fitted on a wheel rim inside a tire, in which on completion of the partial cross-linking phase the toroid ring (2) is placed in an oven (1) to undergo an expansion phase therein, wherein during the expansion phase the toroid ring (2) is rotated in a vertical plane by a horizontal rotating spindle (3) which supports said toroid ring along its inner circumference (Ci).

2. The process according to claim 1, in which the temperature in the oven (1) is between 130° C. and 160° C.

3. The process according to claim 1, in which the temperature in the oven (1) is between 140° C. and 150° C.

4. The process according to claim 1, in which the oven (1) is at atmospheric pressure.

5. The process according to claim 1, in which the rotation speed of the toroid ring (2) during the expansion phase is between 0.1 and 2 rad/sec.

6. An expansion oven (1) designed for the expansion of a toroid ring (2) formed of a partially cross-linked material which is designed, in the fully cross-linked and expanded state, to constitute at least in part a safety support having a closed-cell alveolar structure, wherein the expansion oven comprises a horizontal rotating spindle (3) designed to support the toroid ring (2) at its inner circumference (Ci), and means for driving said rotating spindle in rotation.

7. The oven according to claim 6, provided with a system for the circulation of hot air capable of regulating the temperature in the oven to a value between 130° C. and 160° C.

8. The oven according to claim 7, in which the horizontal rotating spindle (3) is arranged so that the toroid ring (1) is positioned in a plane of symmetry of the thermal flux of the oven (1).

9. The oven according to claim 6, in which the portion (31) of the rotating spindle (3) which supports the toroid ring (2) has a barrelled shape.

10. The oven according to claim 6, in which the rotating spindle (3) is provided with lateral flanges (6, 6′) mounted to rotate freely about the rotating spindle on either side of the portion (31) designed to support the toroid ring during the expansion phase.

11. The oven according to claim 6, in which at least one optical cell (4, 4′) enables the evolution of the expansion level of the toroid ring to be followed.
